(19) United States
(12) Patent Application Publication
(10) Pub. No.: US 2012/0104187 A1
(43) Pub. Date: May 3, 2012

(54) HANGER DEVICE AND METHOD OF PRODUCING THE SAME

(76) Inventor: Ran KRAMER, Caesarea (IL)

(21) Appl. No.: 13/287,197

(22) Filed: Nov. 2, 2011

Related U.S. Application Data
(60) Provisional application No. 61/409,139, filed on Nov. 2, 2010.

(51) Int. Cl. F16L 3/08; B23P 17/04

(52) U.S. Cl. 248/74.3; 29/428

(57) ABSTRACT

A hanger device for detachably securing at least one cord, or one or more hanger devices with one or more openable gates, to a body. The hanger device includes a flexible hanging member having an undeformed shape of a sling and a plurality of different deformed shapes, and a locking element for detachably coupling first and second tips of the flexible hanging member. The flexible hanging member, regains the undeformed shape by switching from any the deformed shape in an ambient temperature, without an external manipulation.

### RELATED APPLICATION

This application claims the benefit of priority under 35 USC 119(e) of U.S. Provisional Patent Application No. 61/409,139 filed Nov. 2, 2010, the contents of which are incorporated herein by reference in their entirety.

### FIELD AND BACKGROUND OF THE INVENTION

The present invention, in some embodiments thereof, relates to a hanger device and a method for producing such a hanger device and, more particularly, but not exclusively, to hanger devices with an openable gate, for example for climbing and lifting and methods for producing such hanger devices.

One of the most common hanger devices is the carabiner which is an oval shaped metal loop with spring loaded gate. The carabiner is used to attach cords, such as ropes or chains to elements. There are different kinds of carabiners which vary in size, shape, and/or locking mechanism. In climbing, Halbmastwurfsicherung (HMS), screwgate, which has a gate that can be locked with a screw, snaplink, and wire gate carabiner are the most common types.

During the last years, various carabiners have been developed to provide more functionalities and robustness to the users. For example, U.S. Pat. No. 6,622,354 filed on May 13, 2002 describes a Carabiner which consists of a modified rope receiving member, a pivoting gate member, and a sloped extension arm. This carabiner mitigates the risk of injury to a climber in the event that the climber falls after improperly clipping a rope into the improved carabiner. If the Rope has been clipped improperly, in a fashion known within the art as back-clipping, and the climber falls, the presence of the Sloped Extension Ann serves to divert the rope away from the Pivoting Gate Member, thus preventing the Rope from becoming unclipped from the improved carabiner.

Another example is provided in U.S. Pat. No. 7,540,074, filed on Dec. 1, 2005 which describes locking carabiners employing a reinforcing sleeve. These carabiners include a C-shaped body having a nose region and an end region. A gate including a flanged region housing a receptacle configured to receive the nose region in a receptacle is pivotally mounted at the end region. A sleeve is movably mounted on the gate, allowing the nose region to be secured within the receptacle. The sleeve is closely fitted about the gate at the flanged region, providing support for the flanged region of the gate in a plurality of lateral directions while securing the nose region within the receptacle. The nose of the carabiner may be configured to be received entirely within the receptacle.

### SUMMARY OF THE INVENTION

According to some embodiments of the present invention, there is provided a hanger device for detachably securing at least one cord to a body. The hanger device comprises a flexible hanging member having an undeformed shape of a sling and a plurality of different deformed shapes and a locking element for detachably coupling first and second tips of the flexible hanging member. The flexible hanging member regains the undeformed shape by switching from any of the plurality of deformed shapes, in an ambient temperature, without an external manipulation.

Optionally, the flexible hanging member is in a close state when the locking element couples the first and second tips and in an open state when the locking element does not couple the first and second tips, the undeformed shape in the close state is selected from a group consisting of a pyriform shape, an o-ring shape, an offset D shape, and a D-shape shape.

Optionally, the flexible hanging member switches to each the deformed shape from the undeformed shape under manual manipulation force.

More optionally, undeformed shape in the close state has lateral sides, an upper side, and a lower side, wherein the ratio between a first distance between the upper side and the lower side and a second distance between the lateral sides is changed during the switch.

Optionally, the flexible hanging member is set to deform so as to substantially linearly spread between first and second tips.

More optionally, the flexible hanging member in the open state is set to deform under manual manipulation force in the ambient temperature so as to broaden an opening between the first and second tips.

Optionally, the locking element and the flexible hanging member are hingeless.

Optionally, the plurality of different deformed shapes comprising a plurality of three dimensional (3D) eccentric elliptical shapes.

Optionally, the first and second tips having an opening of at least 2 centimeters therebetween.

Optionally, the locking element has a lower flexibility coefficient than the flexible hanging member.

Optionally, the flexible hanging member comprising at least one cord.

More optionally, the at least one cord is covered at least one elastic layer.

More optionally, the elastic layer comprises at least one sublayer covering the at least one cord, the sublayer having at least one of a first color and a first pattern; wherein an exposure of the at least one of the first color and the first pattern to a viewer is indicative of a wear of the elastic layer.

More optionally, the elastic layer is at least partly transparent so as to allow a user to directly and visually perceive at least a portion of the at least one cord.

More optionally, the at least one elastic layer is made of a material selected from a group consisting of: natural rubber, general butyl rubber, epichlorohydrin rubber, nitrile rubber, hydrogenated nitrile rubber, styrene-butadiene rubber, urethane rubber, fluorinated rubber, silicon rubber, styrene-ethylene-butylene-styrene (SEBS) rubber, ethylene-propylene rubber, ethylene-propylene-diene (EPDM) rubber, butadiene rubber, hypalon, chloroprene, ethylene vinyl acetate rubber and acryl rubber.

More optionally, the at least one cord comprises a plurality of intertwined cords.

More optionally, the at least one cord comprises a plurality of cords having different lengths selected so as to maintain the sling shape in the ambient temperature.

Optionally, the flexible hanging member is made of a materiel selected from a group consisting of: aluminum, metal, steel, and, an alloy.

More optionally, at least one of the plurality of different deformed shapes is narrower and longer than the undeformed shape in the closed state.

Optionally, the flexible hanging member is unstretchable.

Optionally, the hanger device further comprises at least one pulley wheel threaded on the flexible hanging member so as to support the pulling of at least one cord supported on the flexible hanging member.

According to some embodiments of the present invention, there is provided a method of manufacturing a hanger device for detachably securing at least one cord to a body. The method comprises shaping a flexible hanging member to have a shape of a sling and mounting a locking element on the flexible hanging member so as to detachably coupling first and second tips of the flexible hanging member. The flexible hanging member is set to return to the sling shape from a deformation caused by a manual manipulation force in an ambient temperature without an external physical manipulation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a hanger device in an open state for detachably securing one or more cords to a body, according to some embodiments of the present invention;

FIG. 2 is a sectional schematic illustration of an exemplary hanger device with a flexible hanging member that includes a cord covered by a layer of elastic martial, according to some embodiments of the present invention;

FIG. 3 is a schematic illustration of a hanger device with the flexible hanging member, as depicted in FIG. 1 in a close state, according to some embodiments of the present invention;

FIG. 4 is a schematic illustration of the sizes of an exemplary hanger device, according to some embodiments of the present invention;

FIG. 5A is a schematic illustration of the hanger device depicted in FIG. 1 where the opening thereof is broaden, according to some embodiments of the present invention;

FIG. 5B is a schematic illustration of the hanger device that is stretched when a force is applied on one or more of cords which are hanged thereon (cords not shown), according to some embodiments of the present invention;

FIG. 5C is a schematic illustration of a hanger device having a flexible hanging member with two cords in different lengths which are connected to one another so as to form a sling shape, according to some embodiments of the present invention;

FIGS. 5D and 5E are schematic illustrations of a hanger device having a single cord is bended so that two portions thereof are adjacent to one another and stretched along the flexible hanging member, according to some embodiments of the present invention;

FIG. 6A depicts a schematic illustration of a hanger device which is deformed along the contour of a leaned body, according to some embodiments of the present invention;

FIG. 6B depicts a schematic illustration of a hanger device which is deformed to form a three dimensional eccentric elliptical shape, according to some embodiments of the present invention; and

FIG. 7 is a flowchart of a method of manufacturing a hanger device for detachably securing one or more cords to a body, for example as depicted in FIG. 1, according to some embodiments of the present invention.

### DESCRIPTION OF EMBODIMENTS OF THE INVENTION

The present invention, in some embodiments thereof, relates to a hanger device and a method for producing such a hanger device and, more particularly, but not exclusively, to hanger devices with an openable gate, for example for climbing and lifting and methods for producing such hanger devices.

According to some embodiments of the present invention, there is provided a flexible hanger device having an undeformed shape of a sling and a plurality of deformed shapes for detachably securing one or more cords to a body and/or to support the pulling of elements using cords. The hanger device is optionally set to for complying with climbing safety standards. The hanger device includes a flexible hanging member, such as one or more metal cords, with an undeformed shape of a sling. The hanger device further includes a locking element, such as a screwing/twisting/pinning locking mechanism, for detachably coupling first and second tips of the flexible hanging member. The flexible hanging member may be manipulated, optionally manually and/or by a supported cord, to any of a plurality of different deformed shapes. The flexible hanging member regains the undeformed shape in an ambient temperature without any external manipulation. Optionally, the flexible hanging member includes one or more flexible cords which are covered by an elastic layer, such as rubber. Optionally, the flexible hanging member is set to bend around leaned upon objects, such as projections, reducing bending stress and avoiding breakage points. Optionally, the flexible hanging member to regain a preset pyriform shape, o-ring shape, offset D shape, and/or D-shape shape. Optionally, the flexible hanging member is hingeless.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

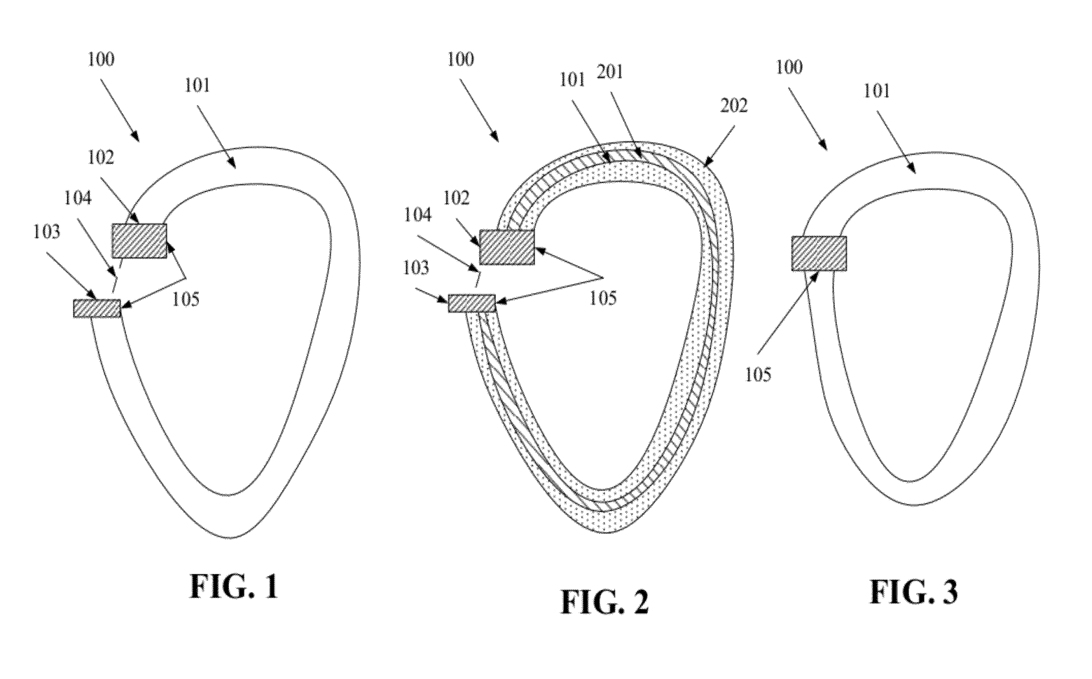

Reference is now made to FIG. 1, which is a schematic illustration of a hanger device 100 for detachably securing one or more cords, such as ropes and/or chains, to a body, such as a projection, a sling, a hook, a jag, and the like, according to some embodiments of the present invention. Optionally, the hanger device 100 functions as either carabiner, Connector or Quick-link for activities requiring ropework, for example climbing, slacklining, caving, canyoning, sailing, and canoeing; and in industrial rope access work, such as construction or window cleaning; and film sets and stunts performing usages.

The hanger device 100, which is depicted in FIG. 1 in an open state, comprises a flexible hanging member 101 that is shaped as an open sling. In an open state, the flexible hanging member 101 has first and second tips 102, 103 with an opening 104 that is formed substantially therebetween. The flexible hanging member 101 is set to switch from any of a plurality of deformed shapes to an undeformed sling shape. The deformed shapes are formed when an external force is applied on the flexible hanging member 101, for example a manual manipulation force, a pressure of a body which is in touch with the flexible hanging member 101, and/or one or more cords which are supported by the hanger device 100. The switch to the undeformed sling shape is done in ambient temperature, optionally without any external force, such as manual or thermal manipulation. For example, FIG. 2 is a sectional schematic illustration of an exemplary hanger device 100 where the flexible hanging member 101 includes a cord 201 that is covered by a layer of elastic martial 202. Optionally, the sectional diameter of the flexible hanging member 101 is between 3 and 30 millimeters.

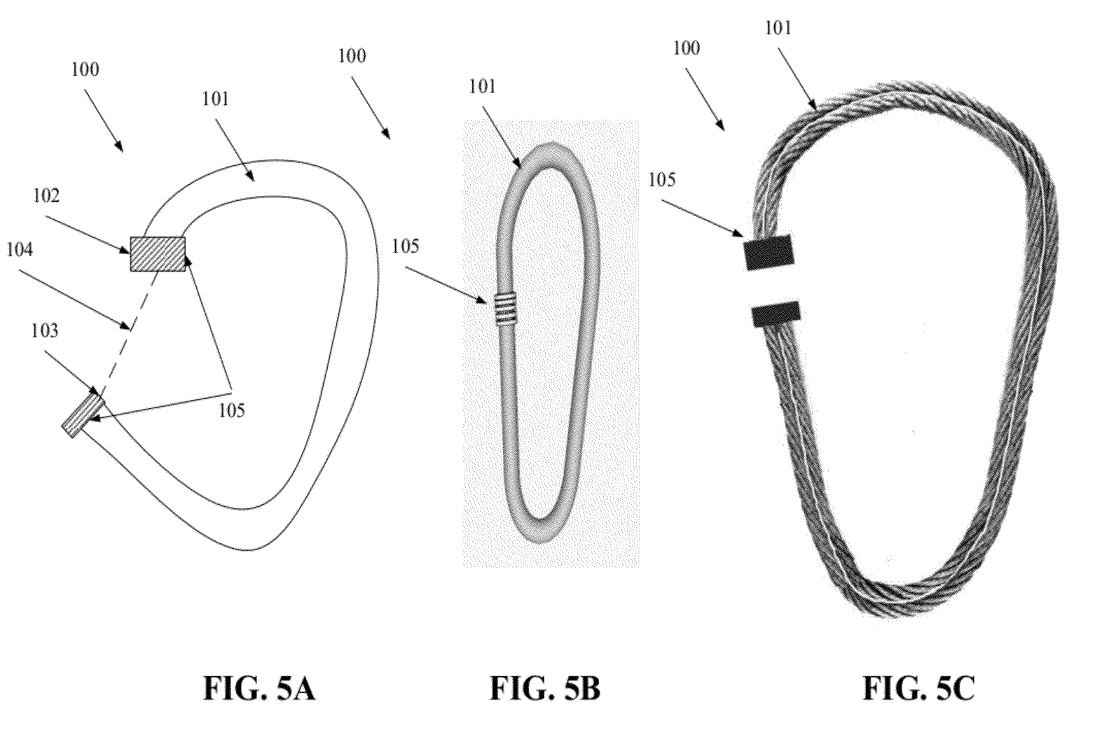

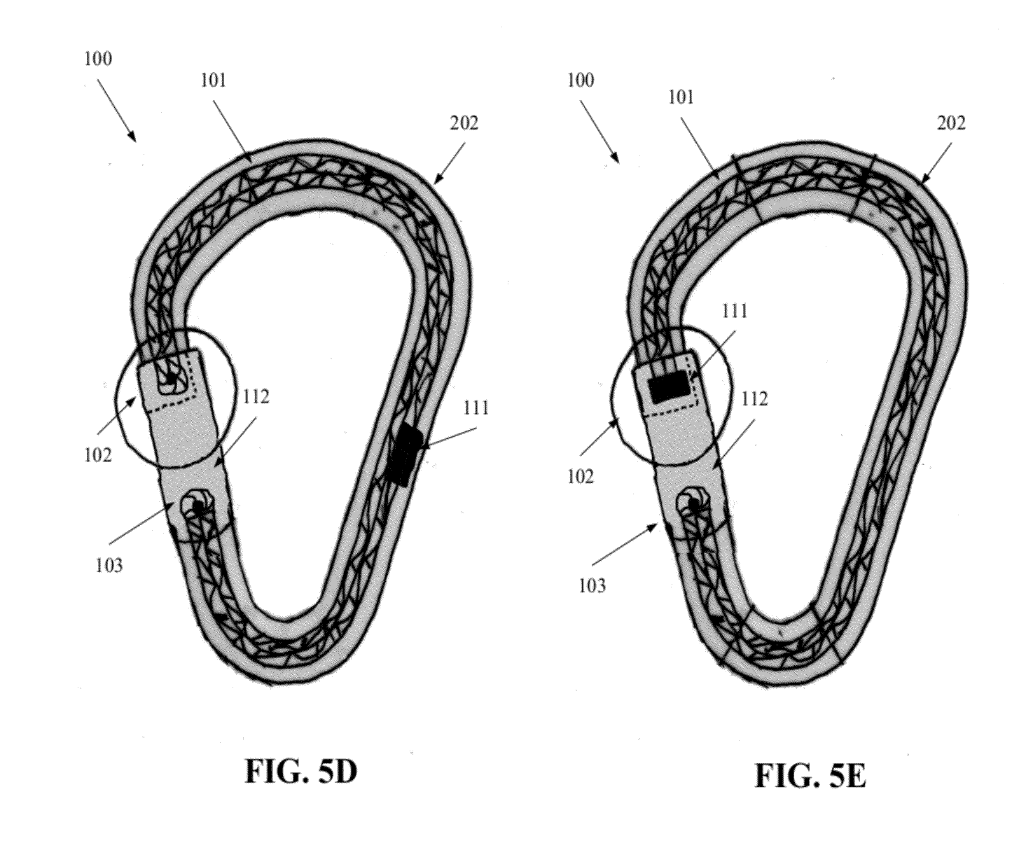

Optionally, the flexible hanging member 101 is made of one or more cords, such as metal cords, optionally intertwined, which are covered, for example laminated, coated, and/or layered, with elastic martial. The cords may be made of an alloy with a shape memory effect that retains the undeformed shape in an ambient temperature. Optionally, the flexible hanging member 101 comprises a plurality of cords in different lengths which are connected to one another so as to form a sling shape. For example, FIG. 5C depicts a hanger device 100 with such a flexible hanging member 101. The figure shows two adjacent wires, connected one along the other so as to maintain a sling shape. Optionally, as shown at FIGS. 5D and 5E a single cord is bended so that two portions thereof are adjacent to one another and stretched along the flexible hanging member 101. Optionally, the single cord is bended in one of the first and second tips 102, 103, for example as shown in FIG. 5D. Optionally, in each bend, a pin is inserted via the cord (via both sides of the bends) to retain the angling of the single cord. In such an embodiment, a cord locking element 111 retains the tips of the cord in the other of the first and second tips 102, 103. In the embodiment depicted in FIG. 5D, the cord locking element 111 firmly attaches the cord tips in parallel to one another, facing a common direction. The cord locking element 111 may be a pressing sleeve that clamps the tips of the cord. Optionally, the cord locking element 111 attaches the cord to the layer of elastic martial 202. Optionally, the single cord is bended at the first and second tips 102, 103. In such an embodiment, the cord locking element 111 retains the tips of the cords in any location, for example under the elastic martial 202, for example as shown at FIG. 5E. In such an embodiment, the cord locking element 111 firmly attaches the cord tips so that they face one another. FIGS. 5D and 5E further depicts a sling locking element 112 which is optionally a rigid sleeve that is used to detachably hold the ends of the flexible hanging member 101 when the flexible hanging member 101 is in a closed state. The sling locking element 112 is optionally firmly attached to one of the ends (i.e. 103 in FIGS. 5D and 5E) of the flexible hanging member 101.
The elastic martial of the cover layer(s) 202 may be natural rubber, general butyl rubber, epichlorohydrin rubber, nitrile rubber, hydrogenated nitrile rubber, styrene-butadiene rubber, urethane rubber, fluorinated rubber, silicon rubber, styrene-ethylene-butylene-styrene (SEBS) rubber, ethylene-propylene rubber, ethylene-propylene-diene (EPDM) rubber, butadiene rubber, hypalon, chloroprene, ethylene vinyl acetate rubber, acryl rubber, and/or any combination thereof.

Optionally, stiffness and/or elasticity coefficient of the cover layer(s) 202 may be unified along the flexible hanging member 101. Alternatively stiffness and/or elasticity coefficient of the cover layer(s) 202 may not be unified along the flexible hanging member 101, for example having different elasticity coefficients in different areas. In such an embodiment, the thickness of the cover layer(s) 202 may not be uniform along the flexible hanging member 101. Optionally, the cover layer(s) 202 is laminated and/or placed to cover only some portions of the flexible hanging member 101.

Optionally, the elastic layer 202 is transparent and/or semi transparent. In such a manner, a user may receive a visual indication pertaining to the completeness and robustness of the covered cords 201. Optionally, the elastic layer 202 comprises color and/or pattern changing indicator to identify wear. The indicator may be formed by generating multiple layers in different colors and/or patterns so that the wearing of one layer exposes the other for a visual sight. In such a manner, the appearance of the color and/or the pattern of a lower layer are indicative of the wear of an upper layer. These indications may be provided by any number of layers to provide graded indications of multiple degrees of layers. Optionally, the elastic layer 202 comprises phosphoric materials and/or compounds that glow in the dark. In such a manner, a user can see the hanger device 100 without illumination and/or from a greater distance. Optionally, the width of the elastic layer 202 is not coherent along the flexible hanging member 101. Some portions of the flexible hanging member 101 may be set as wider than the others, for example the upper and bottom sides of the flexible hanging member 101. Optionally, one or more pulley wheels are threaded on the flexible hanging member 101. The pulley wheels allow reducing the wear that is caused by pulling cords which are supported by the flexible hanging member 101. Optionally, the flexible hanging member 101 has niches, for example in the elastic layer 202, for locating the pulley wheels. Additionally or alternatively a smooth piece of metal is threaded on the flexible hanging member 101. The smooth piece of metal is optionally fixed (not spinning) and used to reduce friction.

The flexible hanging member 101 further includes a locking element 105 for detachably closing the opening by coupling the first and second tips 102, 103. The locking element 105 may include any of various locking mechanisms. For example, the locking element 105 includes a pin based locking mechanism, a twist locking mechanism, and/or a screw lock mechanism. When a pin based mechanism is used, one of the tips 102, 103 is connected to one or more pins which are sized and shaped to fit into respective one or more wells which are formed in the other of the tips 102, 103. The pins and the wells may be part of the flexible hanging member 101 and/or connected thereto. When a screw lock mechanism is used, one of the tips has a helical groove or thread formed on its surface to feet a sleeve that twists up and down on the other of the tips. In use, the user brings one of the tips 102, 103 towards the other and couples them, either by a twisting action, a screwing action, and/or by placing pins into wells. The tips 102, 103 may be brought near one another as the flexible hanging member 101 is flexible.

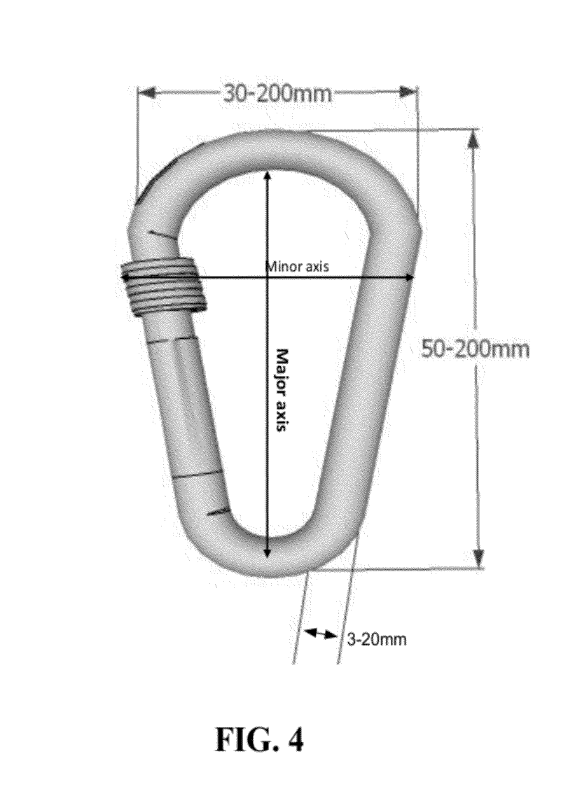

Optionally, in a close state, when the tips 102, 103 are coupled by the locking element 105, the hanger device 100 is set to support weights and cords at least as defined at ASTM F1774-99 (2005) Standard Specification for Climbing and Mountaineering Carabiners, which is incorporated herein by reference. For example, as shown at FIG. 4 the length of the hanger device 100 along a longitudinal axis, referred to herein as a minor axis, is between 30 and 200 millimeters and the length of the hanger device 100 along a latitudinal axis, referred to herein as a major latitudinal axis is between 50 and 200 millimeters. Such a hanger device 100 is set to support 20 kilo Newton (kN) along the latitudinal axis and 7 kN along the longitudinal axis without tear, wear or breakage

Optionally, for example, the hanger device weights between about 10 gram and 150 gram, for example 20 gram and 100 gram.

Optionally, the flexibility coefficient of the locking element 105 is higher than the flexibility coefficient of the flexible hanging member 101. In such an embodiment, the locking element 105 is made of a rigid non flexible material, such as steel and/or a rigid composition of polymers.

Optionally, no hinge is involved in the process locking process. In such an embodiment, the flexible hanging member 101 and the locking element 105 do not have hinges and therefore may be considered as hingeless. FIG. 3 depicts the hanger device 100 with the flexible hanging member 101 in a close state. When no hinge is used, the flexibility of the flexible hanging member 101 allows bringing the tips together for locking.

As described above, the flexible hanging member 101 may be deformed to various deformed shaped, either by manual manipulations and/or by the force applied by cords which are passing therethrough and hanged thereupon. When, the flexible hanging member 101 is in an open state, it may be manipulated to broaden the opening 104, for example as shown at FIG. 5A. In such a manner, the flexible hanging member 101 may be threaded via narrow slits and apertures and/or allow the placing of wide cords and/or rods within the interior space of the hanger device 100. Optionally, the flexible hanging member 101 is set to deform in an ambient temperature so as to substantially linearly spread between the tips 102, 103. For example, the user may deform the flexible hanging member 101 to receive a thread-like shape. Optionally, the flexible hanging member 101 is deformed to broaden the opening to more than 2 centimeters, more than 4 centimeters, more than 8 centimeters and/or to an opening with any intermediate or wider opening diameter. Clearly, the opening depends on the total size of the flexible hanging member 101.

It should be noted that rigid non flexible hangers, such as carabiners, have an opening with a fixed inner diameter that allow the threading thereof via slits of no more than a certain size and/or the placing of cords and/or rods with no more than a certain diameter within its the interior space. These limitations are an outcome of the fixed shape and angles of the carabiners and their openings. As the hanger device 100 has an opening with a variable length in an ambient temperature and a flexible hanging member it is less limited and therefore may be used with smaller slits and for wider ropes/rods than a carabiner with a similar thickness.

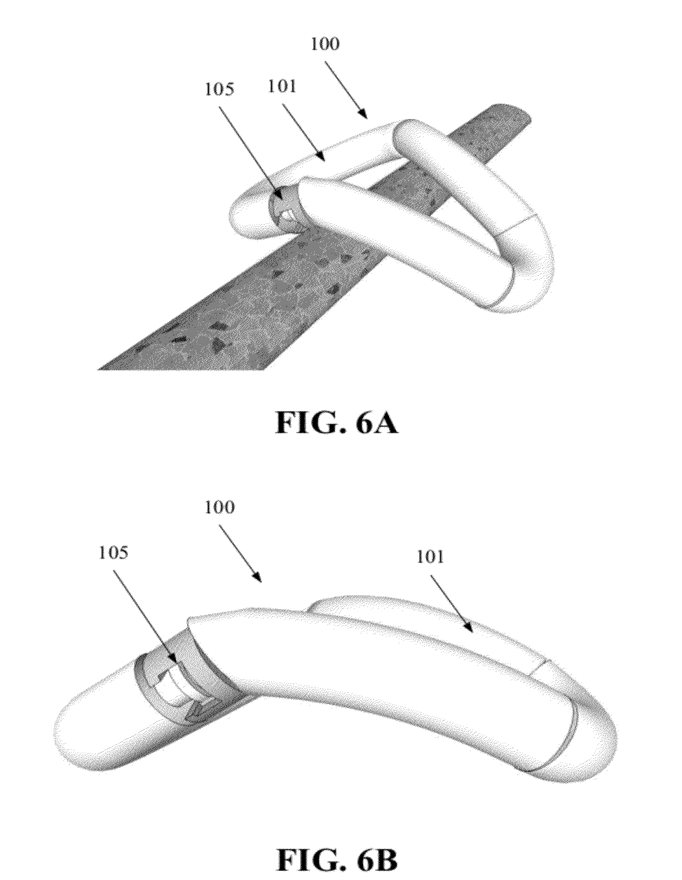

As the flexible hanging member 101 is flexible, a bending stress which is applied thereon by an applied force causes it to deform. For example, when force is applied on the hanger device 100 when it leans on a body that applies stress thereon, for example as shown at FIG. 6A, the hanger device 100 deforms without breaking or causing permanent distortion. The deformation changes the orientation of the flexible hanging member 101 so that applied force distributed along a number of contact points and not accumulated in one or two contact points. In addition, bending stress is induced at points subjected to loads. When a load is applied perpendicular to the length of a beam, bending moments are induced in the beam. As the flexible hanging member 101 deforms, no or less bending moments are formed in beams therealong. In such a manner, the flexible hanging member 101 is less exposed to wearing and/or breaking which are induced by such bending moments. In such a manner the deformability of the flexible hanging member 101 allows generating a hanger device which is less some effected wearing and/or breaking forces and therefore more robust and resistant.

In addition, the elasticity of the flexible hanging member 101 reduces its fragility in a case of dropping. The elasticity of the flexible hanging member 101, which is increased in relation to rigid elements due to his flexibility, absorbs most of the applied energy from an impacting object or impacted surface and therefore allows it to absorb sudden shock loads that would break or wear similar hangers in case of dropping.

As described above, the hanger device 100 may be deformed to various shapes. When more than two external forces are applied on the flexible hanging member 101, for example when three or more cords are supported from by the hanger device 100 from three or more directions, the flexible hanging member 101 is deformed to provide a shape with three or more vertexes, optionally rounded. For example, when three cords apply three forces from three different directions a triangular shape is received.

As depicted in FIG. 3, the flexible hanging member 101 may have a pyriform undeformed shape in a close state. Other undeformed shapes in a close state may be an o-ring shape, an offset D shape, and a D-shape shape.

Optionally, the total length of the hanger device 100 may be stretched when a force is applied on one or more of cords which are hanged thereon. For example, FIG. 5B depicts a hanger device that is stretched when a force is applied on one or more of cords which are hanged thereon (cords not shown). It should be noted that the flexible hanging member 101 is not stretched but rather deformed and therefore not overstretched when the force which is applied thereon is less than an allowed limit. Optionally, the limit is defined according to ASTM F1774-99 (2005) Standard Specification for Climbing and Mountaineering Carabiners, which is incorporated herein by reference. The prolongation of the hanger device 100 by the forces which are applied thereon functions as a suspension mechanism that protects a load that is supported by the hanger device 100, for example in a case of an abrupt falling. The prolonging softens the affect of the applied force, absorbing some of its energy. In such embodiments, the flexible hanging member 101 and/or the locking element 105 are not stretched and/or torn when the hanger device 100 carries weights below the set limits. The applied force changes the ratio between a distance between an upper side and a lower side of the hanger device 100 and a distance between the lateral sides of the hanger device 100.

As described above, the flexible hanging member 101 may deform to different shapes. For example, the flexible hanging member 101 may be deformed by manual manipulation, by forced applied by one or more hanged cords, and/or by the body to which it is connected. Optionally, the deformed shape is a three dimensional (3D) eccentric elliptical shape, for example as shown at FIG. 6B. Optionally, when a number of cords are hanged on the hanger device 100, the deformed shaped may be a 3D eccentric triangular, a 3D eccentric quadrangular, a 3D eccentric pentagon and the like.

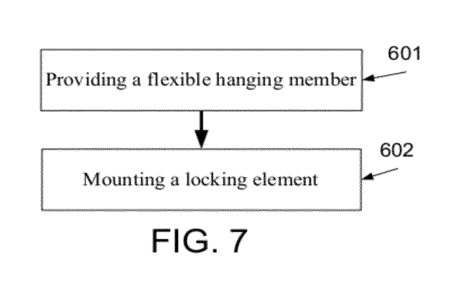

Reference is now made to FIG. 7, which is a flowchart of a method of manufacturing a hanger device for detachably securing one or more cords to a body, for example as depicted in FIG. 1, according to some embodiments of the present invention. First, as shown at 601, a flexible hanging member, such as 101, is shaped to have a sling shape with first and second tips and an opening therebetween in an open state, for example as described above and depicted in FIG. 1. Optionally, a group of cords in different lengths, such as metal cords are sized, for example cut and shaped, for example by connecting elements, to form a sling shape. In another embodiment, cords made of an alloy with a shape memory effect are generated to retain the undeformed shape of a sling in an ambient temperature. These cords are optionally covered by one or more elastic layers, as described above. The elastic layer provides an ergonomic grip to the user as it has a low slipperiness coefficient in relation to metal or other materials which are used for creating hanging members. The elastic layer protects the flexible hanging member 101, which is the force baring securing element, from being eroded.

Now, as shown at 602, a locking element is mounting on the flexible hanging member, for example on its tips as shown at FIG. 1, so as to detachably close the opening 104. The locking element may be any of a plurality of locking mechanisms, as described above. The flexible hanging member is set to return to the sling shape from a deformation caused by a manual manipulation force in an ambient temperature without an external physical manipulation, for example as described above. It is expected that during the life of a patent maturing from this application many relevant devices and methods will be developed and the scope of the term cord, elastic layer, and a material with a shape memory effect is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The terms “such as” and “exemplary” are used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A hanger device for detachably securing at least one cord to a body, comprising:
a flexible hanging member having an undeformed shape of a sling and a plurality of different deformed shapes; and
a locking element for detachably coupling first and second tips of said flexible hanging member;
wherein said flexible hanging member regains said undeformed shape by switching from any of said plurality of deformed shapes, in an ambient temperature, without an external manipulation.

2. The hanger device of claim 1, wherein said flexible hanging member is in a close state when said locking element couples said first and second tips and in an open state when said locking element does not couple said first and second tips, said undeformed shape in said close state is selected from a group consisting of a pyriform shape, an o-ring shape, an offset D shape, and a D-shape shape.

3. The hanger device of claim 1, wherein said flexible hanging member switches to each said deformed shape from said undeformed shape under manual manipulation force.

4. The hanger device of claim 2, wherein undeformed shape in said close state has lateral sides, an upper side, and a lower side, wherein the ratio between a first distance between said upper side and said lower side and a second distance between said lateral sides is changed during said switch.

5. The hanger device of claim 1, wherein said flexible hanging member is set to deform so as to substantially linearly spread between first and second tips.

6. The hanger device of claim 2, wherein said flexible hanging member in said open state is set to deform under manual manipulation force in said ambient temperature so as to broaden an opening between said first and second tips.

7. The hanger device of claim 1, wherein said locking element and said flexible hanging member are hingeless.

8. The hanger device of claim 1, wherein said plurality of different deformed shapes comprising a plurality of three dimensional (3D) eccentric elliptical shapes.

9. The hanger device of claim 1, wherein said first and second tips having an opening of at least 2 centimeters therebetween.

10. The hanger device of claim 1, wherein said locking element has a lower flexibility coefficient than said flexible hanging member.

11. The hanger device of claim 1, wherein said flexible hanging member comprising at least one cord.

12. The hanger device of claim 11, wherein said at least one cord is covered at least one elastic layer.

13. The hanger device of claim 11, wherein said elastic layer having a plurality of elasticity coefficients along said at least one cord.

14. The hanger device of claim 11, wherein said elastic layer alternately covers said at least one cord.

15. The hanger device of claim 1, wherein said flexible hanging member comprising a single cord which is bended at first and second tips of said sling so that two portions thereof are adjacent to one another all along said hanger device.

16. The hanger device of claim 15, further comprising a cord locking element for firmly attaches cord tips of said single cord to on another.

17. The hanger device of claim 16, wherein said cord locking element is not placed in said first and second tips.

18. The hanger device of claim 16, wherein said cord locking element firmly attaches said cord tips so that said cord tips face one another.

19. The hanger device of claim 11, wherein said elastic layer comprises at least one sublayer covering said at least one cord, said sublayer having at least one of a first color and a first pattern; wherein an exposure of said at least one of said first color and said first pattern to a viewer is indicative of a wear of said elastic layer.

20. The hanger device of claim 11, wherein said elastic layer is at least partly transparent so as to allow a user to directly and visually perceive at least a portion of said at least one cord.

21. The hanger device of claim 12, wherein said at least one elastic layer is made of a material selected from a group consisting of: natural rubber, general butyl rubber, epichlorohydrin rubber, nitrile rubber, hydrogenated nitrile rubber, styrene-butadiene rubber, urethane rubber, fluorinated rubber, silicon rubber, styrene-ethylene-butylene-styrene (SEBS) rubber, ethylene-propylene rubber, ethylene-propylene-diene (EPDM) rubber, butadiene rubber, hypalon, chloroprene, ethylene vinyl acetate rubber and acryl rubber.

22. The hanger device of claim 11, wherein said at least one cord comprises a plurality of intertwined cords.

23. The hanger device of claim 11, wherein said at least one cord comprises a plurality of cords having different lengths selected so as to maintain said sling shape in said ambient temperature.

24. The hanger device of claim 1, wherein said flexible hanging member is made of a materiel selected from a group consisting of: aluminum, metal, steel, and, an alloy.

25. The hanger device of claim 2, wherein at least one of said plurality of different deformed shapes is narrower and longer than said undeformed shape in said closed state.

26. The hanger device of claim 1, wherein said flexible hanging member is unstretchable.

27. The hanger device of claim 1, further comprising at least one pulley wheel threaded on said flexible hanging member so as to support the pulling of at least one cord supported on said flexible hanging member.

28. A method of manufacturing a hanger device for detachably securing at least one cord to a body, comprising:
shaping a flexible hanging member to have a shape of a sling; and
mounting a locking element on said flexible hanging member so as to detachably coupling first and second tips of said flexible hanging member;
wherein said flexible hanging member is set to return to said sling shape from a deformation caused by a manual manipulation force in an ambient temperature without an external physical manipulation.
